(19) United States
(12) Patent Application Publication
(10) Pub. No.: US 2006/0277420 A1
(43) Pub. Date: Dec. 7, 2006

(54) Power supply for portable computer

(76) Inventor: Don J. Nguyen, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/144,526

(22) Filed: Jun. 2, 2005

(51) Int. Cl. G06F 1/00

(52) U.S. Cl. 713/300

(57) ABSTRACT

A power supply for a portable computer comprises a power adapter case that houses an AC power adapter circuit and a battery charging circuit. A portable computer using this power supply includes a rechargeable battery but does not require a conventional battery charging circuit. In another implementation, the power supply includes a signal line connecting the AC power adapter circuit to the battery charging circuit, wherein if the AC power adapter circuit is about to overload, the AC power adapter circuit transmits a signal over the first signal line. The battery charging circuit, upon receiving the signal, may cease recharging the batteries. In addition, the portable computer may do one or more of isolating the AC power adapter circuit, commencing a shut down of the portable computer, reducing display brightness, reducing CPU speed, entering a sleep mode, shutting down wireless communications, or shutting down unnecessary peripherals.

### BACKGROUND

Portable computers, such as laptops and notebook computers, generally include an on-board rechargeable battery to provide a power supply for the portable computer when an alternating current (AC) power source, such as an AC power outlet, is unavailable. When an AC power source is available, the portable computer may use an AC power adapter to connect to the AC power source. The AC power source may then power the portable computer as well as recharge the on-board battery.

The portable computer generally includes a battery charger that receives power from the AC power source and directs that power to the rechargeable battery as needed. When the battery is being recharged, the battery charger tends to dissipate quite a bit of power (e.g., 3-4 Watts), depending on the battery charge status and the charge acceptance capability. This power is generally dissipated as heat energy that increases the temperature within the portable computer. An increase in the internal temperature of the portable computer may lead to a decrease in device reliability and potential device failure. Furthermore, the battery charger tends to have a large footprint on the printed circuit board (e.g., the motherboard) of the portable computer. This increases the size of the portable computer and/or takes space away from other components.

In addition to the heat dissipation issues, as conventional portable computers become more demanding of power, conventional AC adapters become more likely to experience an overload which may lead to failure of the adapter. Failure of the AC adapter may cause a relatively instant power loss to the portable computer, possibly resulting in loss or corruption of data.

Accordingly, improved portable computer and AC adapter designs are necessary to improve the reliability and performance of portable computers.

### BRIEF DESCRIPTION OF THE DRAWINGS

FIG. 1 illustrates a generic portable computer power scheme.

FIG. 2 illustrates a portable computer power scheme in accordance with the invention.

FIG. 3 illustrates a first conventional power scheme for a portable computer and an AC power adapter.

FIG. 4 illustrates one implementation of a power scheme for a portable computer and its associated AC power adapter in accordance with the invention.

FIG. 5 illustrates a second conventional power scheme for a portable computer and an AC power adapter.

FIG. 6 illustrates another implementation of a power scheme for a portable computer and its associated AC power adapter in accordance with the invention.

FIG. 7 illustrates an implementation of an AC adapter in communication with a portable computer to address or prevent overload problems.

### DETAILED DESCRIPTION

Described herein are systems and methods of providing power to a portable computer and increasing its reliability and performance. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

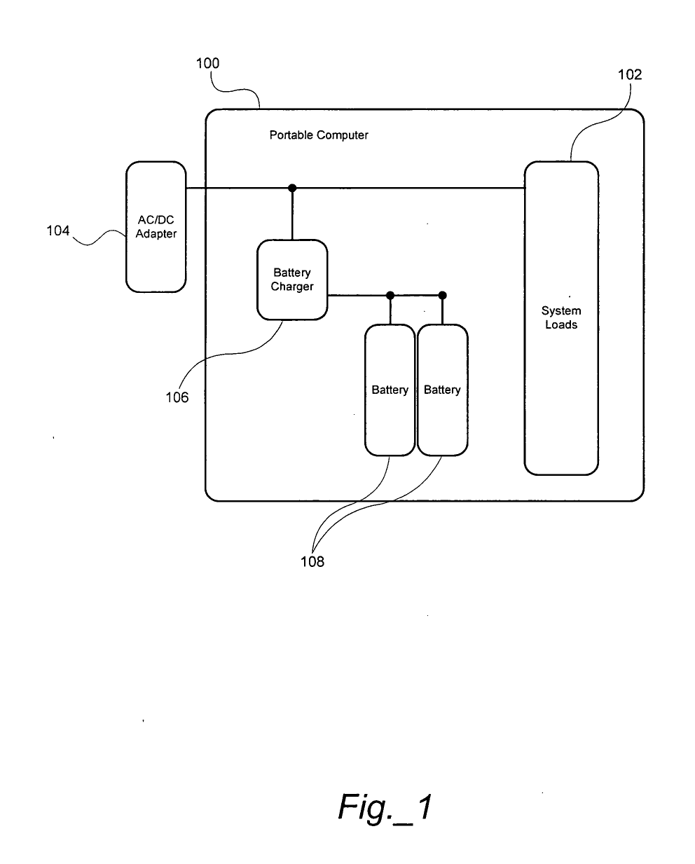

FIG. 1 illustrates a generic portable computer power scheme. A portable computer system 100 is shown having a system load 102. The system load 102 represents the power demands of the portable computer 100 from components that include, but are not limited to, a central processing unit (CPU), a hard disk drive, a random access memory (RAM), a read only memory (ROM), a CD-ROM drive, a DVD drive, a keyboard, a mouse, a monitor, a wireless communications device or platform, as well as other components that are well known to those of ordinary skill in the art. An alternating current (AC) adapter 104 receives power from an AC power source (not shown), such as a standard electrical outlet, and provides that power to the portable computer 100 to supply the power demands of the system load 102. The power is also supplied to a battery changer 106 that uses the power to recharge one or more on-board batteries 108. The batteries 108 provide power to the portable computer 100 when an AC power source is unavailable.

As described above, the battery charger 106 often dissipates a substantial amount of heat energy when it is charging the batteries 108. This heat dissipation increases the internal temperature of the portable computer 100 and therefore decreases the reliability and stability of the portable computer 100. In addition, the battery charger 106 has a large footprint that takes up space within the portable computer 100 that may be used to house other components or that may be eliminated to reduce the size of the portable computer 100.

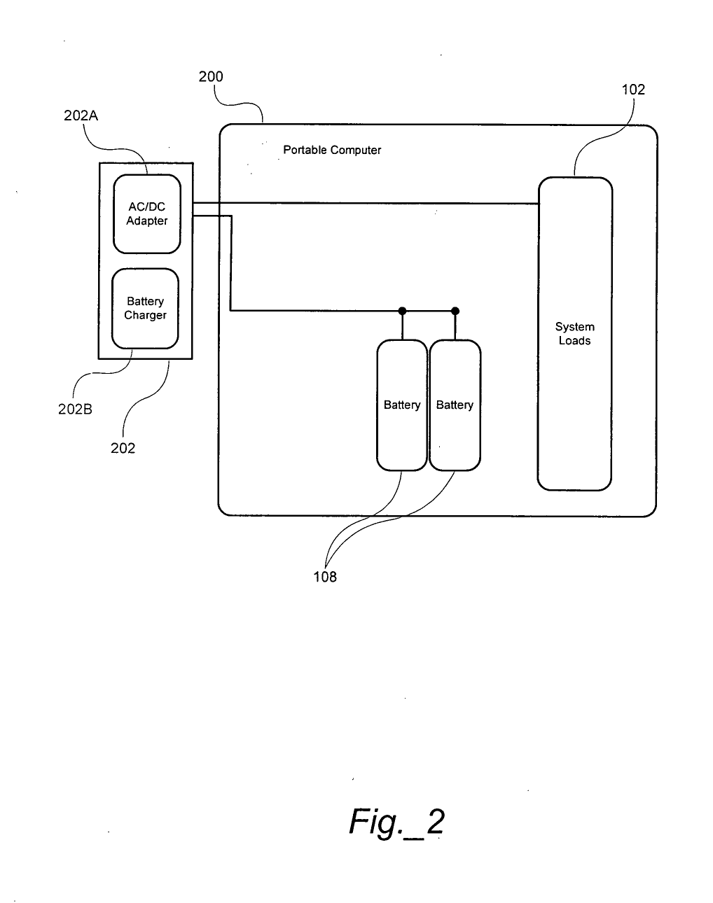

Therefore, in accordance with an implementation of the invention, FIG. 2 illustrates a power scheme for a portable computer 200 that addresses these drawbacks. The portable computer 200 utilizes a novel power adapter 202 that houses both an AC power adapter 202A, such as an AC power adapter circuit, and a battery charger 202B, such as a battery charger circuit. The portable computer 200 still houses the on-board batteries 108 but no longer houses its own battery charger 106.

The implementation shown in FIG. 2 is possible because the battery charger 106 can only operate if the AC adapter 104 is connected and in use. The battery charger 106 needs power from the AC adapter 104 to charge the batteries 108. When the AC adapter 104 is not connected and the portable computer 100 is being powered by the batteries 108, the battery charger 106 serves no function. Since the battery charger 106 can only be used with the AC adapter 104, moving the battery charger 106 outside the portable computer 100 and coupling it to the AC adapter 104 does not hinder the performance of the portable computer 100.

With the battery charger 202B housed in the novel power adapter 202, the heat dissipation is moved outside of the portable computer 200. This increases the reliability and stability of the portable computer 200. This also allows the heat to dissipate more quickly since the heat will not be trapped within the body of the portable computer 200. Additionally, surface area within the portable computer 200 that was previously consumed by the battery charger 106 now becomes available to other components. Alternatively, the portable computer 200 may have a smaller form factor with the removal of the battery charger 106.

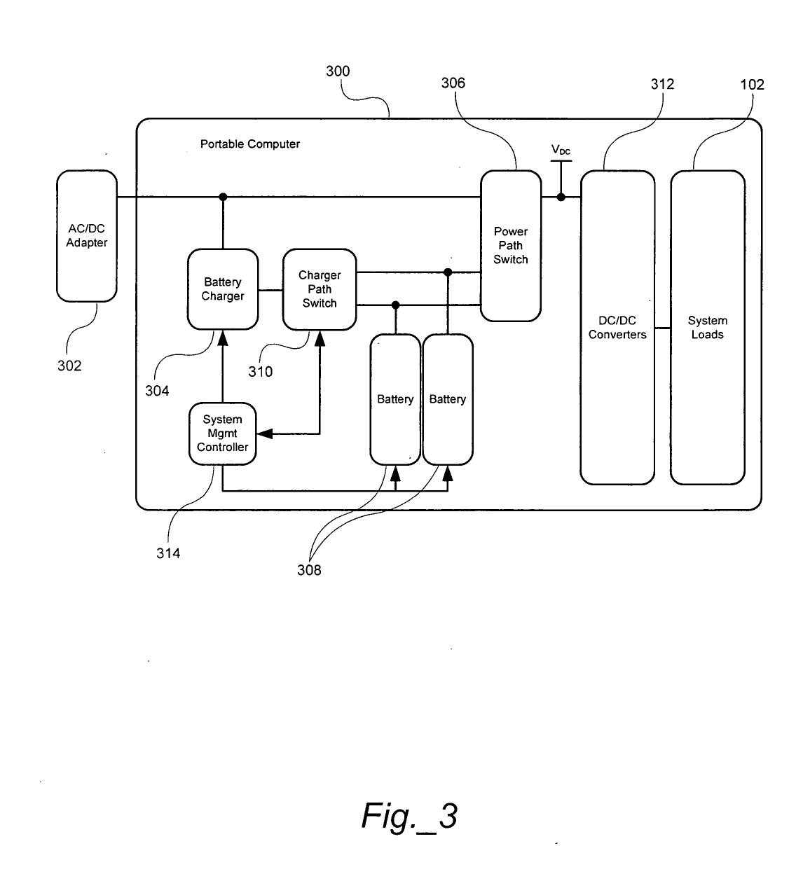

FIG. 3 illustrates a first conventional power scheme for a portable computer 300 and an AC power adapter 302. This first conventional power scheme is used by portable computers with multi-battery pack support, for instance, one battery pack 308 in the main portable computer system 300 and a second battery pack (not shown) in a device-bay, such as a DVD-drive bay or a floppy disk drive bay. As shown, the AC power adapter 302 sources power to a battery charger 304 and a power path switch 306. The battery charger 304 is used to recharge on-board batteries 308 via a charger path switch 310. The charger path switch 310 is used in multi-battery pack systems to provide a mechanism by which the battery packs can be isolated from each other, from the AC power adapter 302, from the battery charger 304, or from the rest of the portable computer 300.

The power path switch 306 is used to direct the flow of power within the portable computer 300. For instance, the power path switch 306 may direct power from the AC power adapter 302 to the system load 102 via a DC/DC converter 312. Alternately, the power path switch 306 may direct power from the batteries 308 to the system load 102 via the DC/DC converter 312. FIG. 3 also illustrates a V_{DC} node that denotes the main power bus that supplies power to the system 300.

The portable computer 300 further includes a system management controller (SMC) 314. The SMC 314 has many functions that are well known in the art. For instance, the SMC 314 can communicate with the batteries 308 (e.g., via a smart battery specification such as SMBus) to gather information such as whether the batteries 308 need to be recharged and how much capacity or run time is left in the batteries. The SMC 314 can use this information to help the portable computer 300 determine where power should be directed and which power sources to use.

In the conventional power scheme shown of FIG. 3, when the AC power adapter 302 is connected, power is directed from the AC adapter 302 to both the battery charger 304 and the power path switch 306 where the power may be supplied to the system load 102. If the batteries 308 need to be recharged, the battery charger 304 can supply power to the batteries 308. In systems that have multi-battery pack support, the battery charger 304 can also supply power to a second battery that is docked in a device-bay.

The battery charger 304 in the conventional power scheme shown in FIG. 3 suffers from the same drawbacks of the system 100 shown in FIG. 1. Namely, the battery charger 304 dissipates a substantial amount of heat while it is supplying power to the batteries 308 and/or the battery in the device-bay. For example, the battery charger 304 may dissipate three to four watts of power while it is recharging the batteries. The battery charger 304 also has a sizable footprint within the portable computer 300. Finally, the battery charger 304 can only be used when the AC adapter 302 is connected. When the AC power adapter 302 is not connected, the battery charger 304 serves no function.

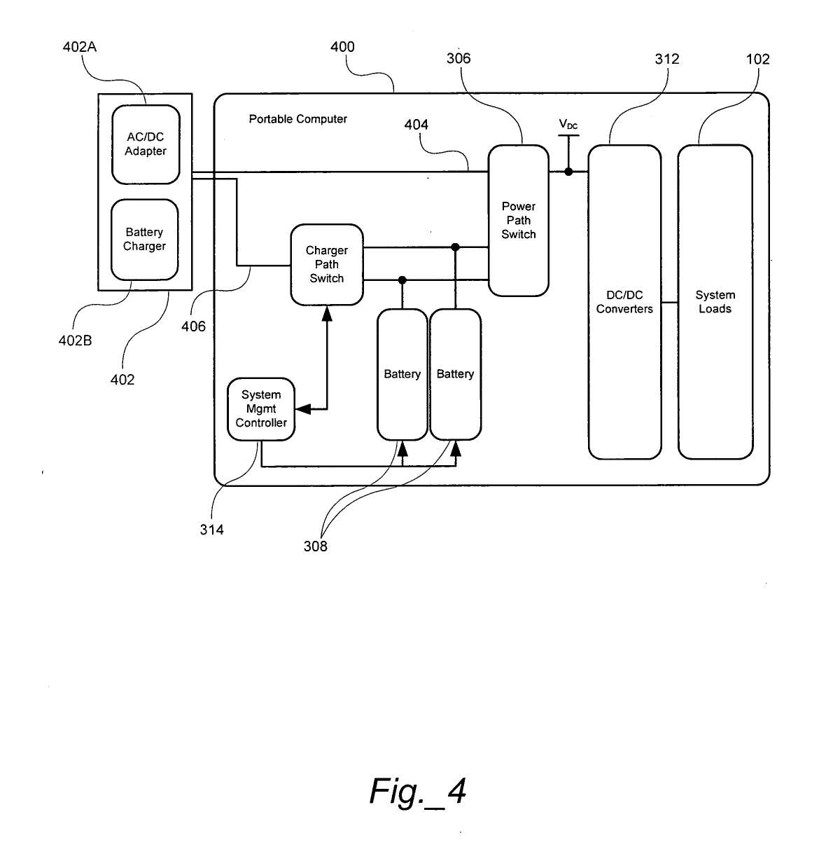

FIG. 4 illustrates a novel power scheme for a portable computer 400 and its associated power adapter 402 that is designed in accordance with an implementation of the invention. The power scheme of FIG. 4 is for use in portable computers based on the first conventional power scheme described in FIG. 3.

The portable computer 400 utilizes a novel power adapter 402 that houses both an AC power adapter 402A and a battery charger 402B. The portable computer 400 still houses on-board batteries 308 but no longer houses the battery charger 304. The portable computer 400 may also house a battery pack (not shown) in a device-bay. Again, this implementation is possible because the battery charger cannot be used without the AC adapter 402 being connected. As such, moving the battery charger outside of the portable computer 400 and housing it with the AC adapter 402A does not hinder the performance of the portable computer 400.

With the battery charger 402B housed in the novel power adapter 402, heat dissipation is moved outside of the portable computer 400, thereby increasing the reliability and stability of the portable computer 400. The heat may dissipate more quickly in this design. Additionally, the footprint within the portable computer 400 previously consumed by the battery charger 304 becomes available to either house other components or to decrease the form factor of the computer 400.

As shown in FIG. 4, the novel power adapter 402 has two traces back to the portable computer 400. A first trace 404 is a power supply line to provide power to address the system load 102. For instance, this may be a normal 19 volt input that conventional portable computers use. A second trace 406 is a power supply line that is the output of the battery charger 402B and provides power to the batteries 308 for recharging. Although not shown, another trace may be included between the novel power adapter 402 and the portable computer 400 for grounding purposes.

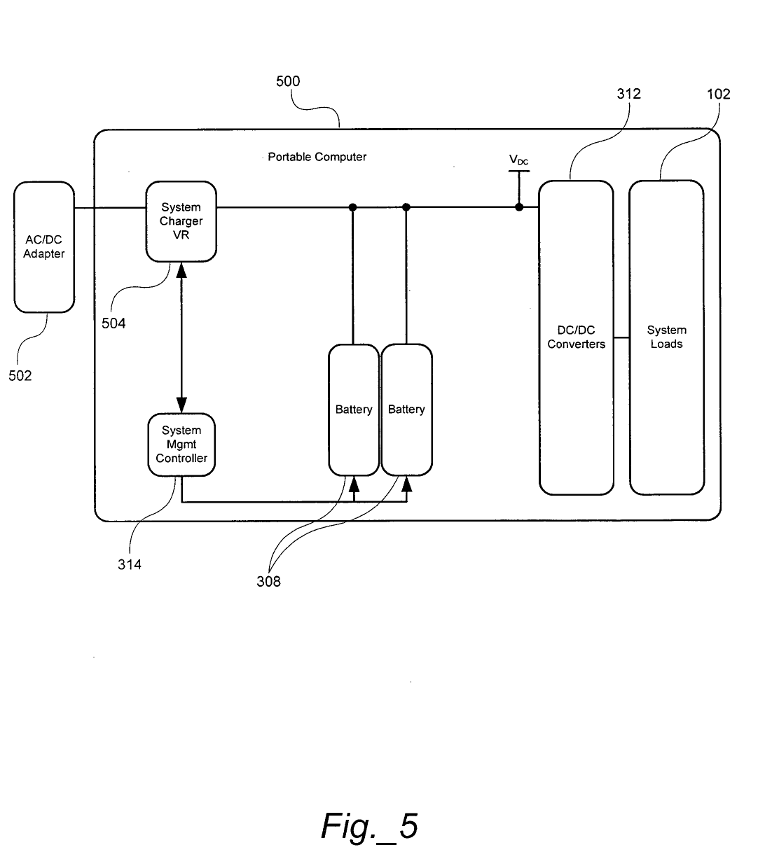

FIG. 5 illustrates a second conventional power scheme for a portable computer 500 and an AC power adapter 502. This second conventional power scheme is known in the art as a “narrow V_{DC}” (NV_{DC}) scheme, which is a design technique to reduce the voltage range of the V_{DC} node. In known power schemes, the AC adapter delivers power in at a voltage that typically ranges up to approximately 19 volts. This voltage range is then provided on the V_{DC} node. In an NV_{DC} power scheme, however, the voltage range is reduced down prior to being delivered to the V_{DC} node. In one implementation, for instance, the power range may be reduced down to about 9 to 12.6 volts. The NV_{DC} power scheme reduces design complexity because the voltage range can be reduced to match the voltage range being used by the components within a portable computer. For example, a generic lithium-ion battery pack with a 3-series configuration/stack operates in the 9 to 12.6 voltage range, so the NV_{DC} power scheme can reduce the incoming voltage range down to 9 to 12.6 volts. Future components or battery packs may operate at different voltage ranges, and as such, the NV_{DC} power scheme may reduce the incoming voltage range down to the appropriate voltage range. The NV_{DC} power scheme also improves the performance of the various DC-DC converters 312 in the portable computer 500.

The NV_{DC} power scheme is implemented using a system charger/voltage regulator (SCVR) 504, shown in FIG. 5. The up to approximately 19 volts of the AC power adapter 502 is isolated from the portable computer 500 by the SCVR 504 so its voltage never reaches the V_{DC} node. The SCVR 504 acts as a gateway that receives the higher input voltage from the AC power adapter 502 (i.e., 19 volts) and then regulates that power down to a lower voltage output (i.e., 9 to 12.6 volts). The SCVR 504 then directs that power to components of the portable computer 500. As such, the V_{DC} node voltage range is only 9 to 12.6 volts.

In addition to regulating the incoming voltage, the SCVR 504 may function as the battery charger 304 described above. The SCVR 504 can therefore direct power to recharge the on-board batteries 308 when receiving power from the AC power adapter 502. The SCVR 504 also delivers power to the DC/DC converters 312 where the power is used to address the system load 102.

The SCVR 504 in the NV_{DC} power scheme shown in FIG. 5 suffers from the same drawbacks of the system 100 shown in FIG. 1 and the system 300 shown in FIG. 3. The SCVR 504 dissipates a substantial amount of heat while it is performing all of its functions, such as regulating down the voltage, supplying power to the system load 102, and supplying power to the batteries 308. For example, the SCVR 504 may dissipate five to eight watts of power while carrying out these functions. The SCVR 504 has a sizable footprint inside the portable computer 500. And as described above, the SCVR 504 can only be used when the AC adapter 502 is connected. When the AC power adapter 502 is not connected, the SCVR 504 serves no function.

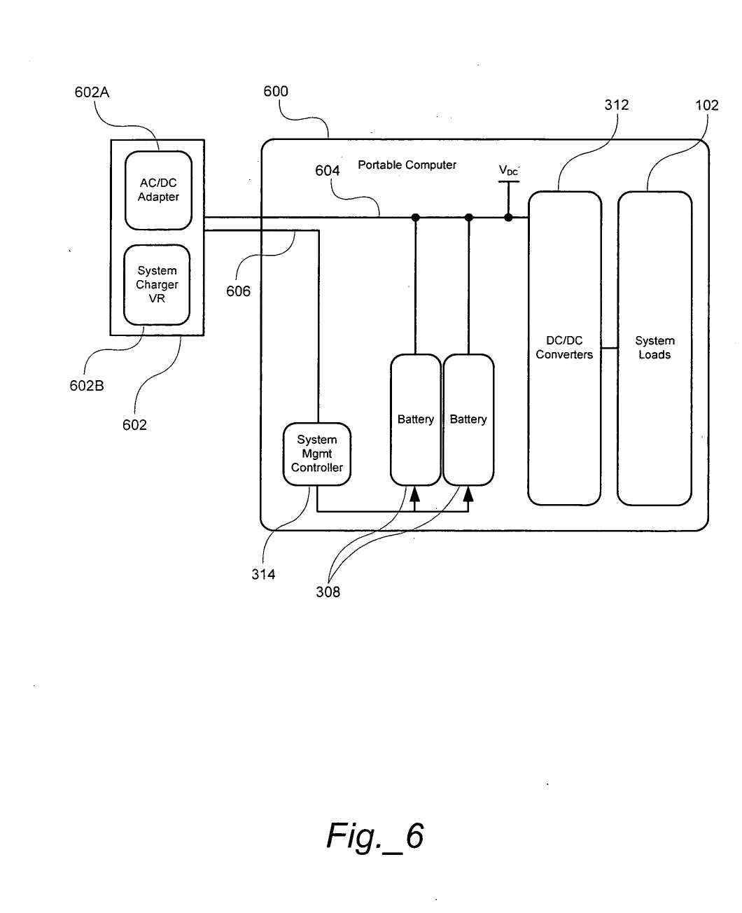

FIG. 6 illustrates a novel power scheme for a portable computer 600 and its associated power adapter 602 that is designed in accordance with an implementation of the invention. The power scheme of FIG. 6 is for use in portable computers based on the NV_{DC} power scheme described in FIG. 5.

The portable computer 600 utilizes a novel power adapter 602 that houses both an AC power adapter 602A and an SCVR 602B. The portable computer 600 still houses on-board batteries 308 but no longer houses the SCVR 504. Once again, this implementation is possible because the SCVR 602B can only be used if the AC power adapter 602A is also in use. As such, moving the SCVR 602B outside of the portable computer 600 and housing it with the AC adapter 602A does not hinder the performance of the portable computer 600.

With the SCVR 602B housed in the novel power adapter 602, heat dissipation is moved outside of the portable computer 600, thereby increasing the reliability and stability of the portable computer 600. The heat may dissipate more quickly in this design. Additionally, the footprint within the portable computer 600 previously consumed by the SCVR 504 becomes available to either house other components or to decrease the form factor of the computer 600.

As shown in FIG. 6, the novel power adapter 602 includes a trace 604 back to the portable computer 600. This trace 604 is a power supply line that provides the 9 to 12.6 volt input that portable computers using an NV_{DC} power scheme use. The trace 604 from the SCVR 602B provides power to address the system load 102 and provides power to the batteries 308 for recharging. Power from the AC adapter 602A is provided only to the SCVR 602B for voltage regulation. The AC adapter 602A does not supply power to the portable computer 600 directly. In one implementation, a trace 606 may also be included to couple the SCVR 602B to the SMC 314. Although not shown, another trace may be included between the novel power adapter 602 and the portable computer 600 for grounding purposes.

It has been observed that power ratings for AC adapters are rising because of the higher power demands of conventional portable computer systems due to ever increasing system loads and from the need to recharge battery packs. This results in even greater heat dissipation within a conventional portable computer system that uses an on-board battery charger. If the AC adapter cannot meet the increasing power demand, the AC adapter may overload and/or fail. Overloading the AC adapter, combined with increasing the internal temperature due to increased heat dissipation, may cause the portable computer system to become less reliable and may lead to system failure.

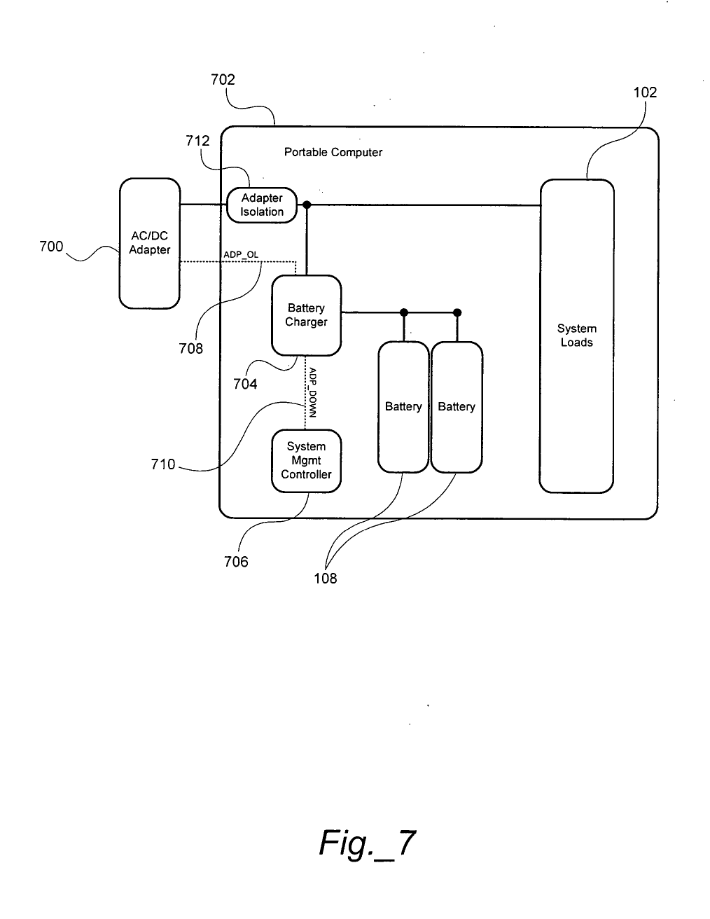

To address this issue, FIG. 7 illustrates an implementation of the invention consisting of a power adapter 700 that is in communication with a portable computer system 702 to address or prevent overload problems. The power adapter 700 is an AC adapter as described above. The portable computer system 702 includes a battery charger 704 that may be mounted within the portable computer 702. In alternate implementations, the battery charger 704 may be housed within the power adapter 700, similar to implementations of the invention described above. The system 702 also includes an SMC 706.

In this implementation, an adapter overload (ADP_OL) signal line 708 is provided that couples the power adapter 700 to the portable computer 702 through, for instance, the battery charger 704. An adapter down (ADP_DOWN) signal line 710 is also provided that couples the battery charger 704 to the SMC 706.

When the power adapter 700 determines that the power demand of the portable computer 702 is too great and an overload of the power adapter 700 is occurring or is imminent, the power adapter 700 can send an “ADP_OL” signal to the battery charger 704 over the signal line 708. The battery charger 704 may then shut down the battery charging circuit to reduce the power demand from the power adapter 700. This action alone may avert a potential overload of the power adapter 700.

The battery charger 704 may also send a “ADP_DOWN” signal to the SMC 706 over the signal line 710. The SMC 706 may then take action to protect the portable computer 702 as it deems necessary. In one implementation, the SMC 706 may isolate the output of the power adapter 700 from the portable computer 702 using, for instance, an adapter isolation circuit 712. In further implementations, the SMC 706 or other components within the portable computer 702 may take further steps towards reducing the load on the battery charger 704, including but not limited to reducing display brightness setting, reducing the CPU speed, entering a sleep or hibernation mode, shutting down wireless communications, or shutting down unnecessary peripherals. The portable computer 702 may continue to operate using the batteries 108 and may undergo a sequential shut down method to preserve data prior to a complete shut down.

In some implementations, the “ADP_OL” signal on line 708 may be a bidirectional signal, thereby allowing the portable computer 702 to send data to the power adapter 700. In an implementation, the portable computer 702 may communicate its desired voltage level and the power adapter 700 may adjust its output voltage. Once this voltage level is acknowledged and met by the power adapter 700, if the voltage level delivered by the power adapter 700 changes from the desired voltage level, the portable computer 702 may determine that a power issue has developed within the power adapter 700, for instance broken wires or an imminent overload. The portable computer 702 may decide to isolate the output of the power adapter 700 and perform a safe sequential shut down prior to a complete power adapter 700 malfunction.

The implementations described with reference to FIG. 7 provide a method by which the power adapter 700 may communicate with the portable computer 702 to alert the portable computer 702 of possible power delivery issues, such as an overload of the power adapter 700. This provides the portable computer 702 with an opportunity to perform a sequential and safe shut down prior to the corruption or loss of data.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. An apparatus comprising:
a power adapter case;
an AC power adapter circuit housed within the power adapter case; and
a battery charging circuit housed within the power adapter case.

2. The apparatus of claim 1, further comprising a first connector capable of being coupled to an AC electrical outlet.

3. The apparatus of claim 2, further comprising a second connector capable of being coupled to a portable computer.

4. The apparatus of claim 3, wherein the AC power adapter circuit is configured to receive power from an AC electrical outlet through the first connector.

5. The apparatus of claim 4, wherein the battery charging circuit is configured to receive power from the AC power adapter circuit.

6. The apparatus of claim 4, wherein the battery charging circuit is configured to deliver power to a rechargeable battery within a portable computer through the second connector.

7. The apparatus of claim 1, further comprising a voltage regulator to reduce an output voltage of the AC power adapter circuit to a level that ranges from 9 to 12.6 volts.

8. An apparatus comprising:
a power adapter case, wherein the power adapter case comprises an AC power adapter circuit and a battery charging circuit;
a portable computer, wherein the portable computer comprises a rechargeable battery and does not comprise a battery charging circuit; and
an electrical connector that couples the power adapter to the portable computer.

9. The apparatus of claim 8, wherein the power adapter case further comprises an AC connector capable of being coupled to an AC electrical outlet.

10. The apparatus of claim 9, wherein the AC power adapter circuit is configured to receive power from an AC electrical outlet through the AC connector.

11. The apparatus of claim 10, wherein the battery charging circuit is configured to receive power from the AC power adapter circuit.

12. The apparatus of claim 11, wherein the battery charging circuit is configured to deliver power to the rechargeable battery through the electrical connector.

13. The apparatus of claim 8, further comprising a voltage regulator to reduce an output voltage of the AC power adapter circuit to a level that ranges from 9 to 12.6 volts.

14. The apparatus of claim 8, wherein the portable computer includes multi-battery pack support.

15. The apparatus of claim 8, wherein the portable computer utilizes a narrow V_{DC} power scheme.

16. An apparatus comprising:
a portable computer;
a power adapter case;
an AC power adapter circuit housed within the power adapter case;
a system management controller circuit housed within the portable computer;
a battery charging circuit electrically coupled to the AC power adapter circuit;
a first signal line connecting the AC power adapter circuit to the battery charging circuit, wherein if the AC power adapter circuit determines it may overload, the AC power adapter circuit transmits a signal over the first signal line.

17. The apparatus of claim 16, wherein the AC power adapter circuit provides power to the portable computer.

18. The apparatus of claim 16, wherein the battery charging circuit is housed within the portable computer.

19. The apparatus of claim 16, wherein the battery charging circuit is housed within the power adapter case.

20. The apparatus of claim 16, wherein if the battery charging circuit receives a signal over the first signal line, the battery charging circuit ceases recharging one or more batteries.

21. The apparatus of claim 16, further comprising a second signal line connecting the battery charging circuit to the system management controller, wherein if the battery charging circuit receives a signal over the first signal line, the battery charging circuit transmits a signal over the second signal line.

22. The apparatus of claim 21, wherein if the system management controller receives a signal over the second signal line, the system management controller isolates the AC power adapter circuit from the portable computer.

23. The apparatus of claim 21, wherein if the system management controller receives a signal over the second signal line, the system management controller commences a sequential shut down of the portable computer.

24. The apparatus of claim 21, wherein if the system management controller receives a signal over the second signal line, the system management controller performs at least one of reducing display brightness setting, reducing the CPU speed, entering a sleep or hibernation mode, shutting down wireless communications, or shutting down unnecessary peripherals.
